(19) United States
(12) Patent Application Publication
(10) Pub. No.: US 2005/0063201 A1
(43) Pub. Date: Mar. 24, 2005

(54) Switching power supply device

(76) Inventor: Yukio Yamazaki, Saitama (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/962,585

(22) Filed: Oct. 13, 2004

(30) Foreign Application Priority Data
Jan. 16, 2003 (JP) 2003-007727

(51) Int. Cl. H02M 3/335

(52) U.S. Cl. 363/21.01

(57) ABSTRACT

This invention offers a switching power supply device which reduces the switching loss. The switching power supply device comprises a switching power supply circuit, and a control circuit which sends a pulse to a main switching element according to the output power of the switching power supply circuit, the control circuit having a triangular waveform generation circuit which generates a triangular waveform signal, the triangular waveform generation circuit connected to a frequency select circuit which selects the frequency of a triangular waveform signal sent, and the frequency select circuit connected to an auxiliary winding provided in the transformer and also to a pulse generator circuit which compares the triangular waveform signal with DC level, wherein the frequency is determined according to the output power by correcting the reference level of the frequency select circuit and detecting a DC level signal supplied by the pulse generator circuit.

### BACKGROUND OF THE INVENTION

1. Field of the Invention

The present invention relates to a switching power supply device, in which its primary and secondary sides are insulated from a main switching element by a transformer.

1. Description of the Related Art

A circuit diagram of a conventional switching power supply device is shown in FIG. 6. The switching power supply device has a main switching element Q1, a switching power supply circuit 1 with its primary and secondary sides insulated by a transformer T1, and a control circuit IC3 which generates a pulse signal to control switching timing of the main switching element Q1.

The drain of the main switching element Q1 comprising an FET is connected serially to one end of the primary winding of the transformer T1 provided in the switching power supply circuit 1. The other end of the primary winding of the transformer T1 is connected to a pole of a DC terminal of a first rectifier bridge D1, and a serial capacitor C4 is connected to the pole of an AC terminal of the rectifier bridge D1. A Photo-coupler PC1 is connected in parallel to the serial capacitor C4. The source of the main switching element Q1 is connected to the pole of the other DC terminal of the first rectifier bridge D1. A smoothing capacitor C8 is provided between these two DC terminals of the rectifier bridge D1 to operate as a DC power supply according to the rectification operation of the first rectifier bridge D1.

A second serial capacitor C3 is connected to the load side of the serial capacitor C4 and to the pole of an AC terminal of the second rectifier bridge D2. The pole of the other AC terminal of the rectifier bridge D2 is connected to a pole of an AC power supply through a capacitor C6. A smoothing capacitor C11 is provided between two DC terminals of the rectifier bridge D2 to operate as a DC power supply according to the rectification operation of the second rectifier bridge D2.

A control circuit IC3 is connected to one of the DC terminals of the second rectifier bridge D2. More particularly, a power input terminal VCC of the control circuit IC3 is connected to one pole of the rectifier bridge D2, and a GND terminal of the control circuit IC3 to the other pole of the rectifier bridge D2. An output terminal OUT of the control circuit IC3 is connected to the gate of the main switching element Q1, and a current detection terminal ISNF of the control circuit IC3 is connected to the source of the main switching element Q1 (Refer to Japanese Published Unexamined Application published by official bulletin No. Hei 10-14227 (see FIG. 1, and Page 3 to 5), etc.).

A switching element Q4 is connected to the secondary side of the switching power supply circuit 1, and its input terminal is connected to a wait signal transmitting circuit 5 which sends a wait signal of an external device to the switching power supply device. A photo-coupler PC1 is connected to the output terminal of switching element Q4. A signal received by the photo-coupler PC1 is received by the AC switching element PC1 to control ON-OFF timing of the main switching element Q1.

The conventional self-exciting switching power supply device (ringing choke converter) has the power limitation of up to about 0.1 to 0.2W in the intermittent mode using the frequency control.

Meanwhile, there is no existing separately-excited switching power supply device in which frequency switching (selecting) type, so that the frequency is kept fixed irrespective of non-load and full load. Thus, switching loss is not reduced even under light load (with less power consumption), thereby causing problems of less efficiency and measurable amount of power consumption.

### SUMMARY OF THE INVENTION

The present invention solves the above problems by providing a switching power supply device which can reduce the switching loss by selecting the frequency according to the output power.

Therefore, the present invention provides a switching power supply device comprises a switching power supply circuit with its primary and secondary sides insulated from a main switching element by a transformer, a control circuit which sends pulse to the main switching element according to the output power of the switching power supply circuit, the control circuit having a triangular waveform generation circuit which generates triangular waveform signal, the triangular waveform generation circuit connected to a frequency select circuit which selects the frequency of triangular waveform signal sent from the triangular waveform generation circuit, and the frequency select circuit connected to an auxiliary winding provided in the transformer and also to a pulse generator circuit which compares triangular waveform signal with DC level, wherein the frequency is determined according to the output power by correcting the reference level of the frequency select circuit and detecting DC level signal supplied by the pulse generator circuit.

In the switching power supply device, the AC power supply and an AC switching element may be provided on the primary side of a switching power supply circuit, AC input voltage of the AC power supply is reduced with less loss through a capacitor and supplied to the AC input terminal of a rectifier bridge in the switching power supply device, a capacitor is connected each to one and other poles of AC input terminal of the rectifier bridge, and each other end of the capacitors is connected to the AC input terminal of another rectifier bridge, DC terminal of which is connected to an auxiliary winding of a transformer. If large output is required, the AC switching element is shorted to send AC input voltage without any reduction.

In the switching power supply device, the frequency select circuit may have a plurality of reference levels to determine the frequency selectively according to the output power.

In the switching power supply device, the control circuit may have a pulse detection circuit which detects gate pulse signal sent from a main switching element, a DC signal level converting circuit which converts pulse signal detected by a pulse detection circuit to DC signal level, and a switching element which is turned on or off by signal generated by the DC signal level converting circuit to send the signal to an AC switching element.

According to the present invention, in order to solve the above problems, the frequency is switched (selected) according to the output power, whereby switching loss is reduced, and the conversion efficiency of the switching power supply is improved and power consumption under light load is reduced. When serial capacitors are provided on the input line, an external signal for the serial capacitors is not required, so that a signal can be detected internally in the switching power supply device.

According to the present innovation, the AC power supply and the AC switching element are provided on the primary side of the switching power supply circuit, the AC input voltage of the AC power supply is reduced with less loss through a capacitor and supplied to the AC input terminal of the rectifier bridge in the switching power supply, and if large output is required, the AC switching element is shorted so as to supply the AC input voltage to the AC terminal of the rectifier bridge of the switching power supply without any reduction of voltage. The capacitor is connected to one and other poles of the AC input terminal of the respective rectifier bridge, and the other end of each of the capacitors is connected to the AC input terminal of another rectifier bridge, DC terminal of the rectifier bridge is connected to an auxiliary winding of a transformer. An auxiliary power supply comprising the auxiliary winding of the transformer reduces drive loss by reducing voltage.

The present invention reduces cost, the number of parts, and the size of the switching power supply device since it eliminates necessity to provide a circuit at the output terminal of the switching power supply circuit to receive external signals, by providing a switching element comprising a photo-coupler in a frequency select circuit, which sends a signal received by the photo-coupler to the input level, and an AC switching element receives this signal so as to control timing of the AC switching element.

### BRIEF DESCRIPTION OF THE DRAWINGS

FIG. 1 shows a circuit diagram illustrating a first embodiment of a switching power supply device according to this invention;

FIG. 2 shows an operation waveform diagram of key components of a switching power supply device according to this invention;

FIG. 3 shows a circuit diagram illustrating a second embodiment of a switching power supply device according to this invention;

FIG. 4 shows a circuit diagram illustrating a third embodiment of a switching power supply device according to this invention;

FIG. 5 shows a circuit diagram illustrating a fourth embodiment of a switching power supply device according to this invention; and

FIG. 6 shows a circuit diagram of a conventional switching power supply device.

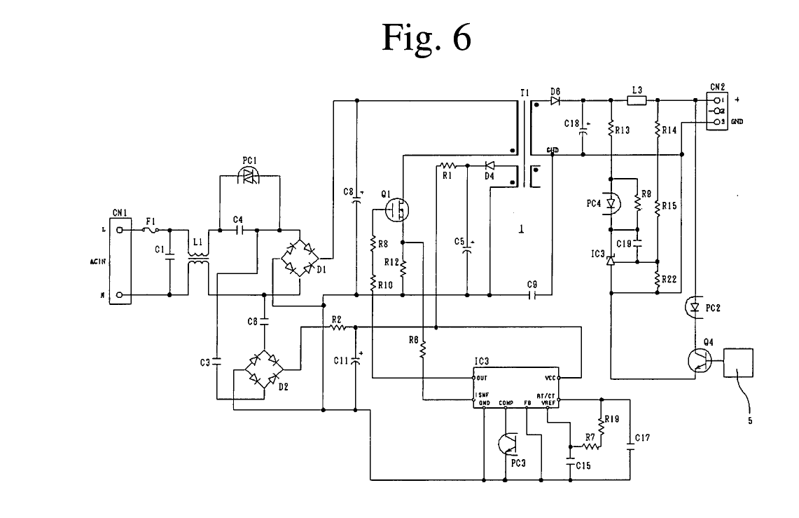

### DESCRIPTION OF THE PREFERRED EMBODIMENTS

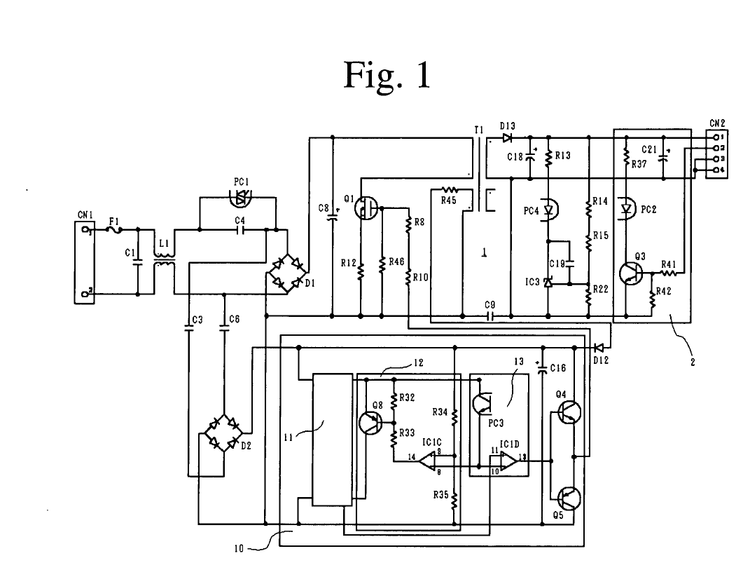

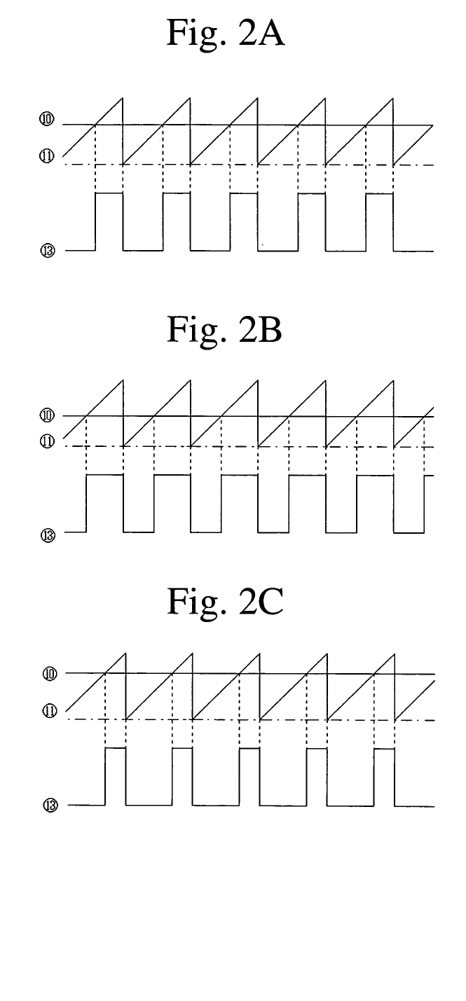

Embodiments of the present invention according to a switching power supply device are described below referring to the diagrams attached hereto. FIG. 1 shows a circuit diagram illustrating an embodiment of the present invention relating to the switching power supply device, and FIG. 2 shows an operation waveform diagram of key components of the switching power supply device according to the present invention. Q1 represents the main switching element, T1 a transformer, PC a photo-coupler, C a capacitor, D a diode, D1, D2 rectifier bridges, R resistor, 1 a switching power supply device, 10 a control circuit, 11 a triangular waveform generation circuit, 12 a frequency select circuit, 13 a pulse generator circuit, 14 a pulse detection circuit and 15 a DC signal level converting circuit.

The drain of the main switching element Q1 comprising an FET is connected serially to one end of a primary winding of the transformer T1 provided in the switching power supply device 1. The other end of the primary winding of the transformer T1 is connected to a pole of the DC terminals of the first rectifier bridge D1, and a serial capacitor C4 is connected to a pole of the AC terminals of the rectifier bridge D1. A photo-coupler PC1 is connected in parallel to the serial capacitor C4. The source of the main switching element Q1 is connected to the other pole of the DC terminals of the first rectifier bridge D1. A smoothing capacitor C8 is provided between these two DC terminals of the rectifier bridge D1 to operate as a DC power supply according to the rectification of the first rectifier bridge D1.

A second serial capacitor C3 is connected to the load side of the serial capacitor C4 and to a pole of the AC terminals of a second rectifier bridge D2. The other pole of the AC terminals of the rectifier bridge D2 is connected to the other pole of an AC power supply via capacitor C6.

A control circuit 10 described hereinafter is connected to one of DC terminals of the second rectifier bridge D2. An auxiliary winding provided in transformer T1 is connected to the other DC terminal of the second rectifier bridge D2 through the control circuit 10 to reduce the drive loss by reducing voltage of the auxiliary power supply comprising the auxiliary winding provided in the transformer T1.

The control circuit 10 is a circuit which sends a pulse signal to control switching timing of the main switching element Q1 of the switching power supply circuit 1. The control circuit 10 has a triangular waveform generation circuit 11 which generates a triangular waveform signal by charging and discharging a capacitor(s) provided therein.

The triangular waveform generation circuit 11 is connected to a frequency select circuit 12 which switches (selects) the frequency of the triangular waveform signal sent from the triangular waveform generation circuit 11. The auxiliary winding provided on the transformer T1 is connected to the frequency select circuit 12, where a comparator IC1C is provided to compare and amplify the reference power supplied from the auxiliary winding provided in the transformer T1 with the output power sent from a pulse generation circuit 13 described hereinafter. The switching element Q8 is connected to the output of the comparator IC1C, and the triangular waveform generation circuit 11 is connected to the switching element Q8 so as to charge and discharge the condenser(s) of the triangle waveform generation circuit 11, thereby switching the frequency according to the output power.

The frequency select circuit 12 is connected to the pulse generation circuit 13 which detects DC level of the triangular waveform signal. The pulse generation circuit 13 is configured to generate a pulse(s) by comparing the reference level varying according to the output power with the triangular waveform signal sent from the triangular waveform generation circuit 11. An output of the pulse generation circuit 13 is sent to the control terminal of the main switching element Q1 through switching elements Q4 and Q5. The frequency select circuit is configured to determine the frequency from the reference level varying according to the output power and the output level. The pulse generation circuit 13 has the light-emitting diode PC2 which is configured to receive an output signal sent from the photodiode PC2 provided on the secondary side of the switching power supply circuit 1. The pulse generation circuit 13 also has a comparator IC1D which is configured to compare an output signal sent from the light-emitting diode PC2 with a triangular waveform signal sent from the triangular waveform generation circuit 11 to generate a pulse(s) which controls the main switching element Q1.

The switching power supply device configured as above operates as described below. Charges transfer between the poles of an AC power supply CN1 and corresponding plates of the serial capacitor C4 to generate AC current. When flowing between the AC power supply CN1 and the serial capacitor C4, the AC current is rectified through the first rectifier bridge D1. This rectification charges a smoothing capacitor C8 to have it operate as a DC power supply. The AC current is also rectified through the second rectifier bridge D2 when it flows between the AC power supply and the two serial capacitors C4 and C3. This rectification charges a smoothing capacitor C11 to have it operate as a DC power supply.

DC power charged in the smoothing condenser C8 is supplied as intermittent primary current by the main switching element Q1 which is turned on and off by a drive pulse(s) outputted from the pulse generation circuit 13 provided in the control circuit 10. The primary current flows through the serial circuit comprising the winding of the transistor T1, the main switching element Q1, and the primary current detection resistor R12 so as to cause induction in the secondary winding and the auxiliary winding of the transistor T1.

As shown in FIG. 2, DC level of the output signal generated by the photodiode PC2 provided on the secondary side of the switching power supply circuit 1 is sent to the light-emitting diode PC2 provided in the pulse generation circuit 13. The output signal of the light-emitting diode PC2 is compared by the comparator IC1D with the triangular waveform signal generated by the triangular waveform generation circuit 11. Depending on an ON or OFF signal generated by the comparator IC1D, the switching elements Q4 and Q5 turn ON or OFF and then the main switching element Q1 turns ON or OFF.

Meanwhile, the output signal generated by the photodiode PC2 on the secondary side of the switching power supply circuit 1 is sent to the frequency select circuit 12 through the light-emitting diode PC2. The output signal is compared by the comparator IC1C with the reference power. When the output signal is larger than the reference power, comparator IC1C generates an ON signal which turns on switching element Q8 provided in the frequency select circuit 12 to charge the capacitor(s) in the triangular waveform generation circuit 11.

Since the output signal generated by the photodiode PC2 on the secondary side of the switching power supply circuit 1 is not always constant, its DC level might be lower. In this case, as the triangular waveform signal is at the fixed level, duration in which triangular waveform signal is larger than the output signal increases and the ON duration of the main switching element Q1 also becomes longer, as shown in FIG. 2. Then, the switching element Q8 in the frequency select circuit 12 is turned OFF, which causes the capacitors provided in the triangular waveform generation circuit 11 to discharge, thereby increasing the frequency of the triangular waveform signal.

Reversely, when the DC level of the output signal is higher, duration in which the triangular waveform signal is smaller than the output signal increases and the ON duration of the main switching element Q1 becomes shorter. Then, the switching element Q8 provided in the frequency select circuit 12 is turned ON, which causes the capacitors in the triangular waveform generation circuit 11 to charge thereby decreasing the frequency of the triangular waveform signal.

In this embodiment of the present invention, the auxiliary winding provided in the transformer T1 is connected to the second rectifier bridge D2 via the control circuit 10, whereby the control circuit 10 receives current induced by the auxiliary winding and DC current rectified by the second rectifier bridge D2, reducing voltage of an auxiliary power supply comprising the auxiliary winding of the transformer T1, thereby reducing drive loss.

In this embodiment of the present invention, the switching power supply circuit having the switching element Q1 connected serially to the winding of the transformer T1 with its primary and secondary sides insulated therebetween is used. However, the switching power supply circuit may not be of the insulating type, but of a non-insulating type using the chopper.

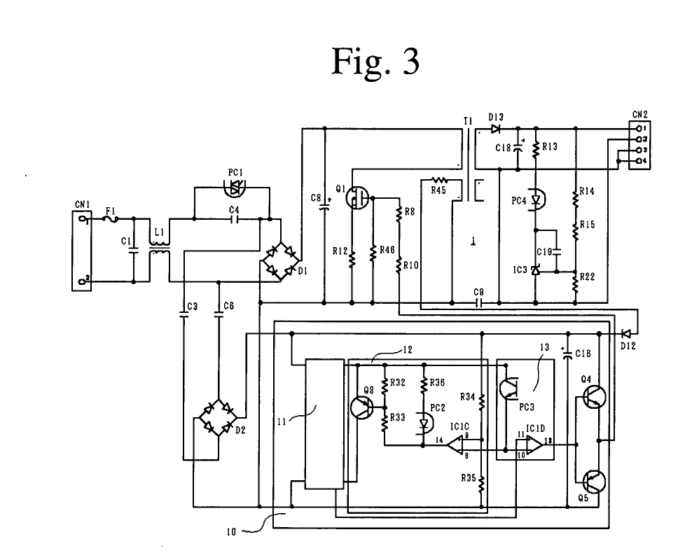

FIG. 3 shows a switching power supply according to a second embodiment of this invention. In this embodiment, the output terminal of the comparator IC1C in the frequency select circuit 12 is connected to a photodiode PC1 which is configured to send a signal to light-emitting diode PC1 provided in the input line, wherein the signal received by the light-emitting diode PC1 controls ON/OFF timing of an AC switching element PC1. Such a configuration eliminates necessity of an external signal receiving circuit 2 provided on the secondary side of the switching power supply circuit 1 shown in the embodiment of FIG. 1, and also enables downsizing of the switching power supply device. This embodiment of the present invention operates almost similarly with the first embodiment shown in FIG. 1.

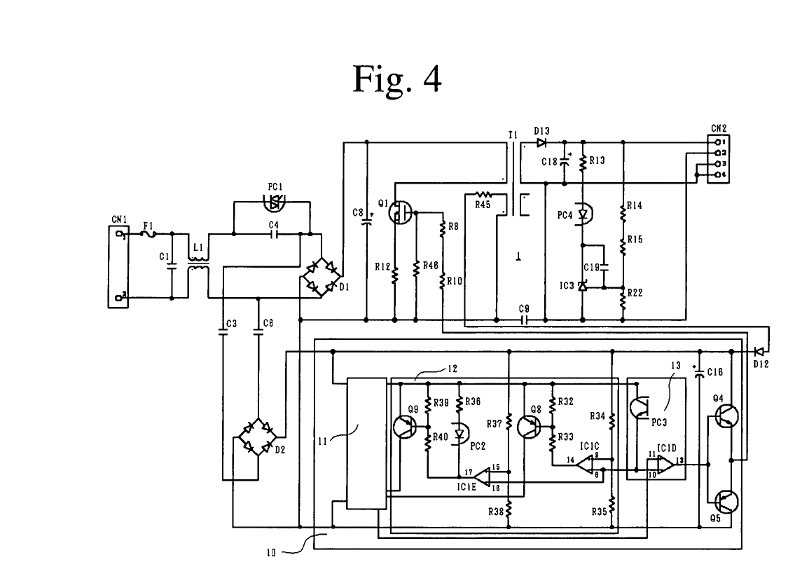

FIG. 4 shows a switching power supply device according to a third embodiment of this invention. In this embodiment, a comparator IC1E is provided in the frequency select circuit 12. Additional reference power units R37 and R38, both with reference power set lower than that of the first reference power units R34 and R35, are connected to the positive input of the comparator IC1E. The comparator IC1E is configured to compare and amplify the reference power sent from an auxiliary winding of the transformer T1 and the output power sent from the DC level of the pulse generator circuit 13. An output of the comparator IC1E is connected to a switching element Q9, which is connected to the triangular waveform generation circuit 11. This configuration charges the capacitor(s) of the triangular waveform generation circuit 11 to select the frequency in a phased manner or in incremental steps according to the output power.

The switching power supply device configured described above operates similarly with the first embodiment shown in FIG. 1. The reference power of the reference power units R37 and R38 connected to the comparator IC1E is set lower than that of the reference power units R34 and R35. When the output power of the first reference power units R34 and R35 is lower than the reference power and the output power of the second reference power units R37 and R38 is higher than the reference power, the comparator IC1C sends an ON signal to turn on the switch element Q8 provided in the frequency select circuit 12 and charge the capacitor(s) provided in the triangular waveform generation circuit 11. On the other hand, the comparator IC1E sends an OFF signal to turn the switching element Q9 off. In this case, the capacitor(s) in the triangular waveform generation circuit 11 is not charged, and the frequency set to the first reference power units becomes lower.

When the output power of the second reference power units R37 and R38 is lower than the reference power, the comparator IC1E sends an ON signal to turn the switching element Q9 on to charge the capacitor(s) in triangular waveform generation circuit 11, thereby reducing the frequency of the triangular waveform signal.

In this embodiment of the present invention, two phases of the reference power are provided. In the meantime, three phases of the reference power or more can be set by providing three or more comparators, reference power units and switching elements, to determine the frequency in a phased manner or in incremental steps according to the output power.

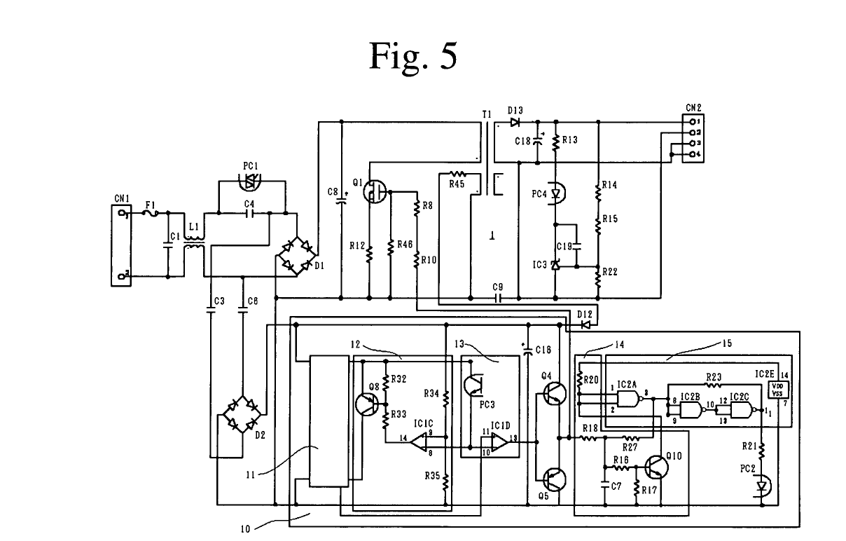

FIG. 5 shows a fourth embodiment of the switching power supply device according to the present invention. In this embodiment, the control circuit 10 is provided with the triangular waveform generation circuit 11, the frequency select circuit 12 and the pulse generator circuit 13, similarly with the first embodiment shown in FIG. 1. The control circuit 10 is also provided with a pulse generation circuit 14 which detects gate a pulse signal sent from the main switching element Q1, and a DC signal level converting circuit 15 which converts the pulse signal detected by the pulse generation circuit 14 to DC signal level. The pulse generation circuit 14 is connected to switching elements Q4 and Q5 provided in the control circuit 10, and the DC signal level converting circuit 15 is connected to the pulse generation circuit 14. A switching element PC1, which is turned on and off by a signal generated by the DC signal level converting circuit 15 to send the signal to the input level, is connected to the DC signal level converting circuit 15.

The pulse detection circuit 14 according to this embodiment is provided with resistors R16, R17 and R18 and capacitor C7. An input terminal of the pulse detection circuit 14 is connected to the gate of the main switching element Q1 and the switching elements Q4 and Q5 of the control circuit 10, and the output terminal of the pulse detection circuit 14 is connected to the base of a switching element Q10 comprising a transistor. Any desired value of the pulse signal can be selected by setting a desired circuit layout of the resistors R16, R17 and R18 and capacitor C7 and a desired resistance value and capacitance of respective elements.

In the DC level converting circuit 15 according to this embodiment, the switching element Q10 of the pulse detection circuit 14 is connected to the input terminal of a first NOT circuit IC2A, and the output terminal of the first NOT circuit IC2A is connected to the input terminal of a second NOT circuit IC2B. The output terminal of the second NOT circuit IC2B is connected to the input terminal of a third NOT circuit IC2C. Such a configuration converts pulse signal detected by the pulse generation circuit 14 to DC signal level.

The DC signal level converting circuit 15 has a switching element which is turned on and off by a signal generated by the DC signal level converting circuit 15. The switching element comprises a photodiode PC1 which is connected to the output terminal of the third NOT circuit provided in the DC signal level converting circuit 15, via a resistance R21. The photodiode PC1 receives the signal at the light-emitting diode PC1 provided on the input level. This signal is sent to the AC switching element PC1 to control ON/OFF timing of the AC switching element PC1.

The switching power supply device configured as above operates as described below. An operation of the triangular waveform generation circuit 11, the frequency select circuit 12 and the pulse generator circuit 13 is almost same as that of the first embodiment shown in FIG. 1. A drive pulse sent from the pulse generator circuit 13 is detected by the pulse detection circuit 14 via the switching elements Q4 and Q5. Level of the drive pulse is adjusted through the resistors R16, R17, R18 and capacitor C7 provided in the pulse generation circuit 14 and then reversed and sent by the switching element Q10 to the DC signal level converting circuit 15.

DC signal level converting circuit 15 converts a signal sent through the switching element Q10 to DC signal level. The signal sent from the first NOT circuit IC2A is sent to the second NOT circuit IC2B. A signal from the second NOT circuit IC2B is sent to the third NOT circuit IC2C. While passing through those NOT circuits IC2A, IC2B and IC2C, the rectangular signal is converted to DC signal level.

The signal converted to DC level is sent to the photodiode PC1, where the light-emitting diode PC1 on the input line receives the signal to control the AC switching element PC1.

Thus, according to the present invention, advantages described below can be obtained.

This invention reduces the switching loss, improves the conversion efficiency of the switching power supply and reduces the power consumption under light load by selecting the frequency based on the output power. Also, when serial capacitors are provided on the input line, an external signal for the serial capacitor is not required so that the signal can be detected internally in the switching power supply device.

An AC power supply and an AC switching element provided on the primary side of the switching power supply circuit reduces AC input voltage of the AC power supply through a capacitor without voltage loss and supplies it to the AC input terminal of rectifier bridge in the switching power supply. If large output is necessary, the AC switching element is shorted to supply AC input voltage to the AC input terminal of a rectifier bridge in the switching power supply without any voltage drop. A capacitor is connected to one and other poles of the AC input terminal of rectifier bridge and the other end of the capacitors is respectively connected to the AC input terminal of another rectifier bridge, DC terminal of the rectifier bridge is connected to the auxiliary winding of transformer, so that drive loss can be reduced by reducing voltage of the auxiliary power supply thus configured by the auxiliary winding of the transformer.

A switching element comprising a photo-coupler is provided in the frequency select circuit. Signal received by the photo-coupler is sent to the input level, where the AC switching element receives the signal to control the switching timing of the main switching element. Such configuration eliminates necessity of an external signal receiving circuit at the output terminal of the switching power supply circuit, reducing the number of components and cost and size of the switching power supply device.

Thus the present invention possesses a number of advantages or purposes, and there is no requirement that every claim directed to that invention be limited to encompass all of them.

The disclosure of Japanese Patent Application No. 2003-007727 filed on Jan. 16, 2003 including specification, drawings and claims is incorporated herein by reference in its entirety.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A switching power supply device comprising:
a switching power supply circuit with its primary and secondary sides insulated from a main switching element by a transformer, and
a control circuit which sends pulse to said main switching element according to the output power of said switching power supply circuit, said control circuit having a triangular waveform generation circuit which generates triangular waveform signal, said triangular waveform generation circuit connected to a frequency select circuit which selects the frequency of triangular waveform signal sent from said triangular waveform generation circuit, and said frequency select circuit connected to an auxiliary winding provided in said transformer and also to a pulse generator circuit which compares triangular waveform signal with DC level,
wherein the frequency is determined according to the output power by correcting the reference level of said frequency select circuit and detecting DC level signal supplied by said pulse generator circuit.

2. The switching power supply device according to claim 1, wherein an AC power supply and an AC switching element are provided on the primary side of a switching power supply circuit, AC input voltage of said AC power supply is reduced with less loss through a capacitor and supplied to the AC input terminal of a rectifier bridge in said switching power supply device, a capacitor is connected each to one and other poles of AC input terminal of said rectifier bridge, and each other end of said capacitors is connected to the AC input terminal of another rectifier bridge, DC terminal of which is connected to an auxiliary winding of a transformer. If large output is required, said AC switching element is shorted to send AC input voltage without any reduction.

3. The switching power supply device according to claim 1, wherein a frequency select circuit has a plurality of reference levels to determine the frequency selectively according to the output power.

4. The switching power supply device according to claim 2, wherein a frequency select circuit has a plurality of reference levels to determine the frequency selectively according to the output power.

5. The switching power supply device according to claim 1, wherein a control circuit has a pulse detection circuit which detects a gate pulse signal sent from a main switching element, a DC signal level converting circuit which converts pulse signal detected by a pulse detection circuit to DC signal level, and a switching element which is turned on or off by a signal generated by said DC signal level converting circuit to send the signal to an AC switching element.

6. The switching power supply device according to claim 2, wherein a control circuit has a pulse detection circuit which detects a gate pulse signal sent from a main switching element, a DC signal level converting circuit which converts pulse signal detected by a pulse detection circuit to DC signal level, and a switching element which is turned on or off by a signal generated by said DC signal level converting circuit to send the signal to an AC switching element.

7. The switching power supply device according to claim 3, wherein a control circuit has a pulse detection circuit which detects a gate pulse signal sent from a main switching element, a DC signal level converting circuit which converts pulse signal detected by a pulse detection circuit to DC signal level, and a switching element which is turned on or off by a signal generated by said DC signal level converting circuit to send the signal to an AC switching element.

8. The switching power supply device according to claim 4, wherein a control circuit has a pulse detection circuit which detects a gate pulse signal sent from a main switching element, a DC signal level converting circuit which converts pulse signal detected by a pulse detection circuit to DC signal level, and a switching element which is turned on or off by a signal generated by said DC signal level converting circuit to send the signal to an AC switching element.
